(19) United States
(12) Patent Application Publication
(10) Pub. No.: US 2003/0120586 A1
(43) Pub. Date: Jun. 26, 2003

(54) Systems and methods to facilitate analysis of commercial credit customers

(76) Inventor: Charles J. Litty, Southbury, CT (US)

Correspondence Address: BUCKLEY, MASCHOFF, TALWALKAR, & ALLISON, 5 ELM STREET, NEW CANAAN, CT, 06840, US

(21) Appl. No.: 10/026,104

(22) Filed: Dec. 21, 2001

(51) Int. Cl. G06F 17/60

(52) U.S. Cl. 705/38

(57) ABSTRACT

Systems and methods are provided to facilitate analysis of commercial credit customers. According to one embodiment, customer information associated with a commercial credit customer is determined, at least some of the customer information being associated with a plurality of commercial credit accounts. Risk information associated with the customer is then generated by applying at least one of a plurality of risk models to the customer information. A list of high risk customers may then be created based on the risk information.

### FIELD

The present invention relates to commercial credit customers. In particular, the present invention relates to systems and methods to facilitate analysis of commercial credit customers.

### BACKGROUND

A creditor can extend credit to a customers via a commercial credit account. For example, a commercial credit account might be used to finance a customer's purchase of commercial equipment, such as trucks, machine tools, or telecommunication equipment. In this case, the equipment being purchased is typically used as collateral to secure the credit being extended to the customer. As another example, a commercial credit account might be used when a customer leases commercial equipment. Note that a creditor may extend credit to a single customer via a number of separate commercial credit accounts (e.g., one account may be associated with a purchase of trailers while another account is associated with a purchase of machine tools).

Of course, there is always some risk that a customer will fail to provide payments associated with a commercial credit account. For example, a customer may become bankrupt or simply lack sufficient funds to provide payments in a timely manner. In this case, the creditor can suffer a loss associated with some, or even all, of the credit that had been extended to the customer. This risk can be especially serious with respect to commercial accounts because of the significant amount of credit that is often extended via such accounts.

If a creditor could identify those customers who are more likely to have such problems (i.e., “high risk” customers), the commercial credit accounts associated with those high risk customers could be closely monitored. For example, the creditor might quickly contact a high risk customer when a delayed payment is detected. Moreover, the creditor might be able to re-schedule or otherwise adjust payments to reduce the risk of suffering a loss because of a high risk customer. Note that it may be impractical for a creditor to quickly contact and/or negotiate with each and every customer who delays a payment (e.g., the creditor may be extending credit to hundreds or thousands of customers).

It is known that a risk manager associated with a creditor can manually review commercial credit accounts in an attempt to identify high risk accounts or customers. Such an approach, however, can be subjective and may be inefficient when there are a large number of customers involved. Moreover, the risk manager's task may be further complicated if each customer has a number of separate commercial credit accounts.

It is also known that a statistical model can be applied to commercial credit information in an attempt to identify high risk commercial credit accounts. For example, all accounts that had payment delays of more than thirty days during the last year might be identified as high risk accounts. Applying a single model to all commercial credit accounts, however, may improperly identity some accounts as high risk while failing to identify other accounts that are, in fact, high risk. For example, it might not be uncommon for commercial credit accounts associated with a certain type of collateral to delay payments by more than thirty days. As a result, it would be inefficient to identify such an account as high risk simply because a customer had delayed payment by forty days.

### SUMMARY

To alleviate problems inherent in the prior art, the present invention introduces systems and methods to facilitate analysis of commercial credit customers.

According to one embodiment, customer information associated with a commercial credit customer is determined, at least some of the customer information being associated with a plurality of commercial credit accounts. Risk information associated with the customer is then generated by applying at least one of a plurality of risk models to the customer information.

According to another embodiment, a set of historical customers are identified, each historical customer being associated with at least one commercial credit account. A segmentation analysis is then performed to determine historical customer segments, and potential variables are identified. A univariate analysis is performed on the potential variables to identify potentially predictive variables, and a multivariate analysis is performed on the potentially predictive variables to select most predictive variables. Risk models can then be established using the most predictive variables for each determined customer segment.

Once the risk models are established, internal account data is retrieved and external customer data is received, each being associated with active customers. A subset of active customers can then be identified based on the risk models, internal account data, and external customer data. A notification is then transmitted to one or more risk managers via a communication network.

One embodiment comprises: means for determining customer information associated with a commercial credit customer, at least some of the customer information being associated with a plurality of commercial credit accounts; and means for generating risk information associated with the customer by applying at least one of a plurality of risk models to the customer information.

Another embodiment comprises: means for identifying a set of historical customers, each historical customer being associated with at least one commercial credit account; means for performing a segmentation analysis to determine customer segments; means for identifying potential variables; means for performing univariate analysis on the potential variables to identify potentially predictive variables; means for performing multivariate analysis on the potentially predictive variables to select most predictive variables; means for establishing risk models using the most predictive variables for each determined customer segment; means for retrieving internal account data associated with active customers; means for receiving external customer data associated with the active customers; means for identifying a subset of the active customers based on the risk models, internal account data, and external customer data; and means for transmitting a notification associated with the subset of active customers to at least one risk manager via a communication network.

A technical effect of some embodiments of the present invention is to provide a computer adapted to efficiently facilitate analysis of commercial credit accounts and/or customers.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a customer analysis system according to some embodiments of the present invention.

FIG. 2 is a flow chart of a method according to some embodiments of the present invention.

FIG. 3 is a block diagram including elements of a controller according to some embodiments of the present invention.

FIG. 4 illustrates a watch list display according to an embodiment of the present invention.

FIG. 5 is a block diagram overview of a controller according to an embodiment of the present invention.

FIG. 6 is a tabular representation of a portion of a customer database according to an embodiment of the present invention.

FIG. 7 is a tabular representation of a portion of an account database according to an embodiment of the present invention.

FIG. 8 is a tabular representation of a portion of a risk model database according to an embodiment of the present invention.

FIG. 9 is a tabular representation of a portion of an analysis database according to an embodiment of the present invention.

FIG. 10 is a flow chart of a method for generating risk models according to an embodiment of the present invention.

FIG. 11 is a flow chart of a computer-implemented method for identifying high risk customers according to an embodiment of the present invention.

### DETAILED DESCRIPTION

Embodiments of the present invention are directed to systems and methods to facilitate analysis of customers associated with commercial credit accounts. As used herein, the phrase “commercial credit account” can refer to, for example, any account that is used to extend credit to a commercial customer. For example, credit may be extended to a business in connection with a commercial equipment purchase or lease (e.g., for trucks, trailers, forklifts, machine tools, or telecommunication equipment). Note that a single customer may be associated with a number of different commercial credit accounts.

Customer Analysis System

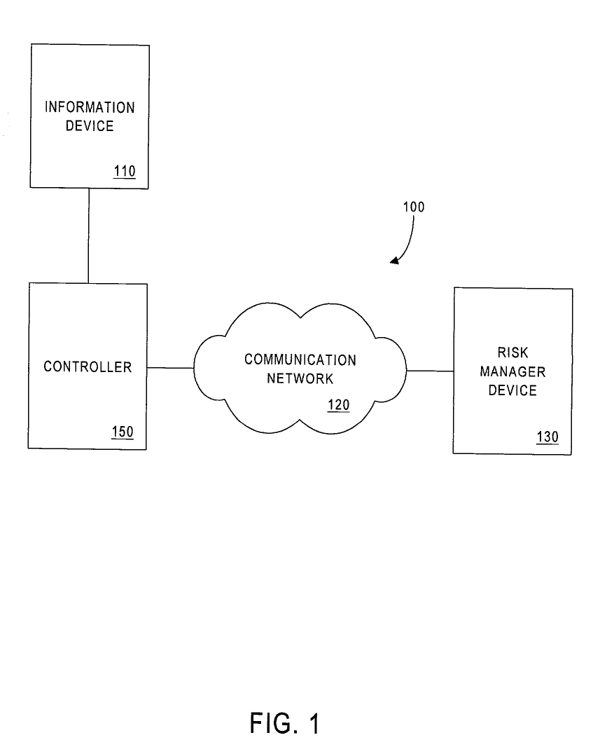

Turning now in detail to the drawings, FIG. 1 is a block diagram of a customer analysis system 100 according to some embodiments of the present invention. The system 100 includes a controller 150 in communication with a risk manager device 130 through a communication network 120. The communication network 120 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet.

The controller 150 and the risk manager device 130 may be any devices capable of performing the various functions described herein. The controller 150 may be associated with, for example, a Web server adapted to perform calculations, analyze information, and provide results in a periodic or substantially real-time fashion. The risk manager device 130 may be, for example, a Personal Computer (PC) adapted to run a Web browser application (e.g., the INTERNET EXPLORER® application available from MICROSOFT®), a portable computing device such as a laptop computer or a Personal Digital Assistant (PDA), and/or a wireless device.

Note that the devices shown in FIG. 1 need not be in constant communication. For example, the controller 150 may communicate with the risk manager device 130 on an as-needed or periodic basis. Moreover, although a single controller 150 and risk manager device 130 are shown in FIG. 1, any number of these devices may be included in the customer analysis system 100. Similarly, a single device may act as both a controller 150 and a risk manager device 130.

The controller 150 also receives information from one or more information devices 110. An information device 110 may comprise, for example, an accounts receivable system associated with a creditor. Note that the controller 150 and the risk manager device 130 might also be associated with the creditor. According to another embodiment, the information device 110 is instead associated with a third-party service that provides business information reports or credit scores, such as EXPERIAN® or D&B, INC.®

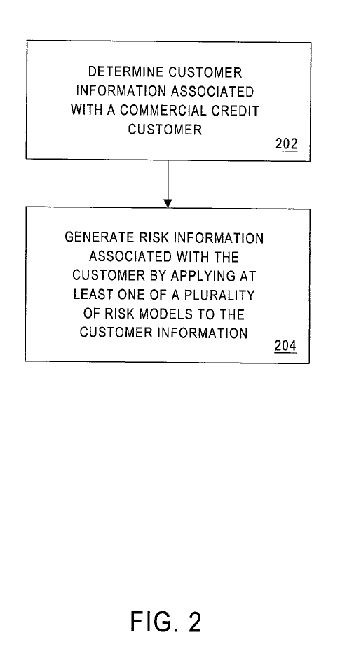

According an embodiment of the present invention, the controller 150 facilitates analysis of commercial credit customers. In particular, FIG. 2 is a flow chart of a method that may be performed by the controller 150 according to some embodiments of the present invention. The flow charts in FIG. 2 and the other figures described herein do not imply a fixed order to the steps, and embodiments of the present invention can be practiced in any order that is practicable.

At 202, customer information associated with a commercial credit customer is determined. For example, the controller 150 may receive information from the information device 110 to determine a business segment associated with the customer (e.g., indicating whether the customer is a manufacturer or a retailer). Similarly, a product type (e.g., “textiles” or “shipping services”) or company type (e.g., a “corporation,” “government agency,” or “partnership”) associated with the customer may be determined.

Other types of customer information that may be determined by the controller 150 include one or more customer characteristics. For example, the controller 150 may receive information from the information device 110 (e.g., an accounts receivable system) to determine a payment history (e.g., indicating that the customer has twice delayed payments by more than sixty days during the past year). As another example, the customer information may be associated with a loss history (e.g., indicating that some of the customer's commercial credit accounts have been partially or entirely written-off), a delinquency status (e.g., indicating if the customer is currently delaying any payments), how long the customer has been receiving credit, and/or an aggregate customer account size.

The customer information may also be associated with one or more commercial credit account characteristics. For example, the original cost or type of collateral being used to secure credit (e.g., “machine tools” or “telecommunication equipment”) may be determined by the controller 150. As another example, the controller 150 may determine financial amounts associated with the account, such as a total balance (e.g., an amount that is currently outstanding), a maximum total balance within a pre-determined period of time (e.g., during the past two years), and a security deposit. Historical information associated with an account, such as the amount of time an account has been open, might also be determined. Similarly, payment timing and amount information (e.g., indicating whether payments have been —or are—delinquent, or whether a payment schedule has been modified) associated with the account may also be determined.

Note that the customer information may be associated with more than one commercial credit account. For example, the controller 150 may aggregate information about five separate commercial credit accounts (each associated with the same customer) when determining the customer information.

At 204, risk information associated with the customer is generated by applying at least one of a plurality of risk models to the customer information. For example, the controller 150 may select one or more appropriate risk models based on some of the customer information (e.g., a first risk model might apply if a customer is a manufacturer while a second risk model would apply if the customer is a retailer).

The risk information may comprise, for example, a risk score (e.g., a risk score from 1 through 100) and/or a risk category (e.g., a “high,” “average,” or “low” risk category) associated with a customer. As used herein the phrase “risk model” refers to any function or series of calculations that uses one or more input parameters (e.g., customer information) to generate one or more risk output parameters.

In addition to the customer information, other parameters may be used by a risk model to generate risk information. For example, industry specific forecasts may be used to generate or adjust risk information for a customer associated with that industry. As another example, overall economic information (e.g., predicted interest rates) may be used to generate or adjust risk information. Such types of information may, for example, be received from a third-party service or may be generated by an independent model.

According to some embodiments of the present invention, the method illustrated in FIG. 2 is performed for a number of different customers. For example, a creditor may perform the method for each of five hundred commercial credit customers on a monthly basis. After generating risk information for each customer, the controller 150 may generate a list of those customers who are associated with the highest risk. The controller 150 may also transmit information associated with the list to one or more risk manager devices 130 via the communication network 120. For example, the controller 150 may transmit the list of high risk customers via a Web site or simply send an electronic mail notification indicating that a new list is available. According to another embodiment, a notification is transmitted to a risk manager if a particular customer has been placed on the list (e.g., the notification is transmitted to the risk manager responsible for that particular customer). The controller 150 may perform such a process, for example, on a periodic basis (e.g., monthly) or in substantially real-time.

According to some embodiments, the information determined and/or generated in FIG. 2 is aggregated on a portfolio level (e.g., the information may be aggregated for an industry or geographic region). In this way, high risk portfolios may be identified and monitored.

### EXAMPLE

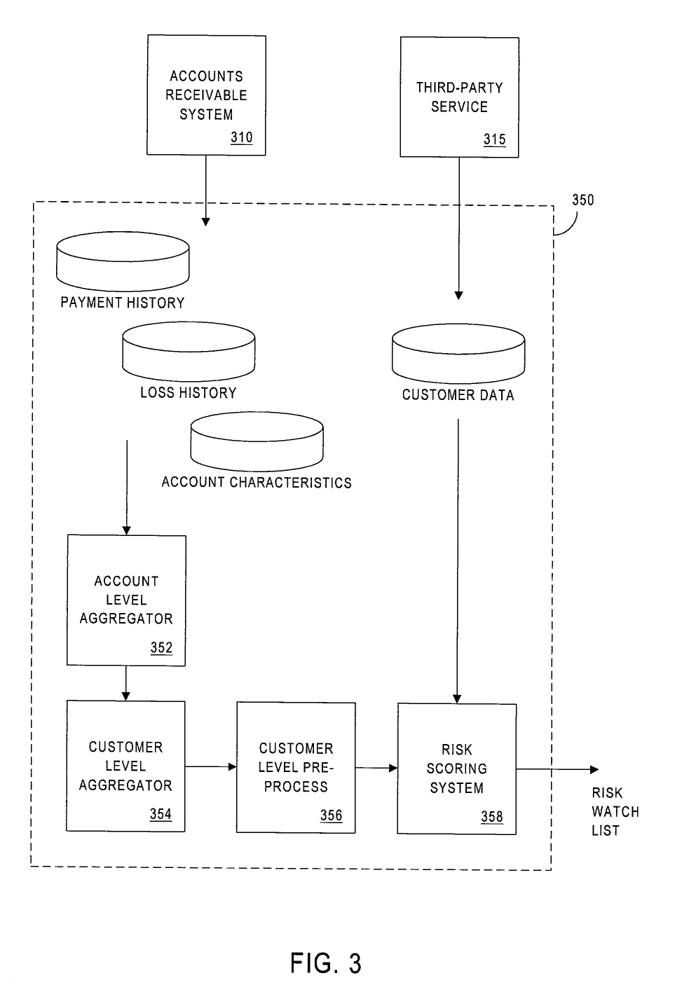

FIG. 3 is a block diagram including elements of a controller 350 according to some embodiments of the present invention. In this case, the controller 350 receives information about a number of commercial credit accounts from an accounts receivable system 310. Based on the received information, a payment history database is updated to indicate whether payments have been made in a timely fashion. Similarly, a loss history database is updated to indicate accounts that have been partially (or entirely) written-off. An account characteristics database is also updated to indicate, for example, the types of collateral that were used to secure commercial credit accounts.

Information from each of these three databases is then provided to an account level aggregator 352. That is, the account level aggregator 352 compiles payment, loss, and characteristic information for each commercial credit account. This information is then provided to a customer level aggregator 354. The customer level aggregator 354 may, for example, compile information about a number of different accounts associated with a single commercial credit customer. A customer level pre-process 356 is then performed to format the customer information before the information is provided to a risk scoring system 358 (e.g., associated with a plurality of risk scoring models).

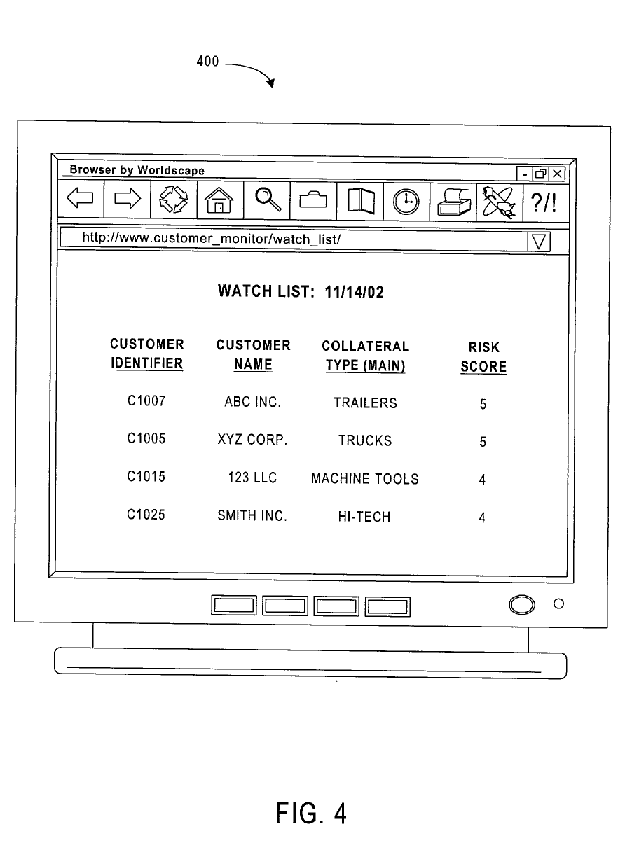

The risk scoring system 358 also receives customer data generated by a third-party service 315. For example, the risk scoring system 358 may receive information generated by D&B, INC.® Based on all of the received information, the risk scoring system 358 outputs a risk “watch list” indicating high risk customers. FIG. 4 illustrates a watch list display 400 according to an embodiment of the present invention. As can be seen, the display 400 includes a date, customer identifiers, customer names, collateral types (e.g., a main collateral type when a customer is associated with a number of different commercial credit accounts), and risk scores. A risk manager may then use this information to more closely monitor high risk customers.

Controller

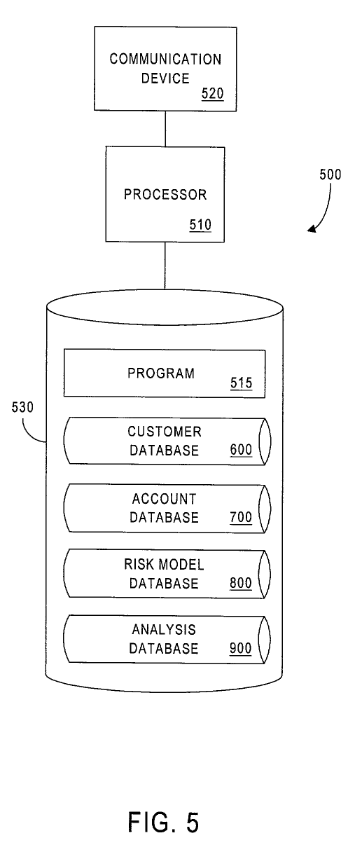

FIG. 5 illustrates a controller 500 that is descriptive of the devices shown, for example, in FIGS. 1 and 3 according to some embodiments of the present invention. The controller 500 includes a processor 510, such as one or more INTEL® Pentium® processors. The processor 510 is coupled to a communication device 520 that may be used, for example, to exchange information with one or more information devices 110, risk manager devices 130, accounts receivable systems 310, and/or third-party services 315.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores one or more programs 515 for controlling the processor 510. The processor 510 performs instructions of the programs 515, and thereby operates in accordance with the present invention. For example, the processor 510 may determine customer information associated with a commercial credit customer, at least some of the customer information being associated with a plurality of commercial credit accounts. The processor 510 may also generate risk information associated with the customer by applying at least one of a plurality of risk models to the customer information.

According to one embodiment, a set of historical customers are identified, each historical customer being associated with at least one commercial credit account. A segmentation analysis is then performed to determine historical customer segments, and potential variables are identified. A univariate analysis is performed on the potential variables to identify potentially predictive variables, and a multivariate analysis is performed on the potentially predictive variables to select most predictive variables. That is, the multivariate process may utilize techniques that examine the pattern of relationships between several potentially predictive variables simultaneously. Risk models can then be established using the most predictive variables for each determined customer segment.

After the risk models are established, internal account data is retrieved and external customer data is received by the processor 510, each being associated with active customers. The processor 510 then identifies a subset of active customers based on the risk models, internal account data, and external customer data. A notification is then transmitted to one or more risk managers via a communication network.

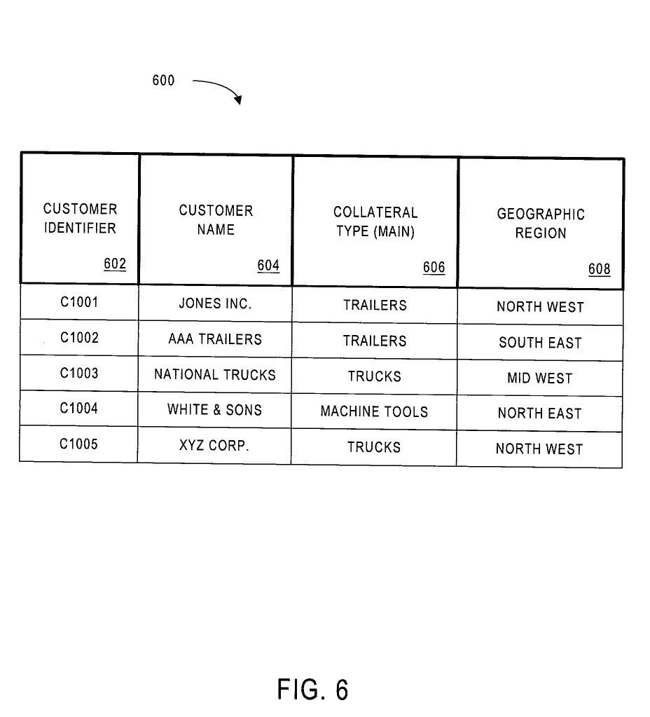

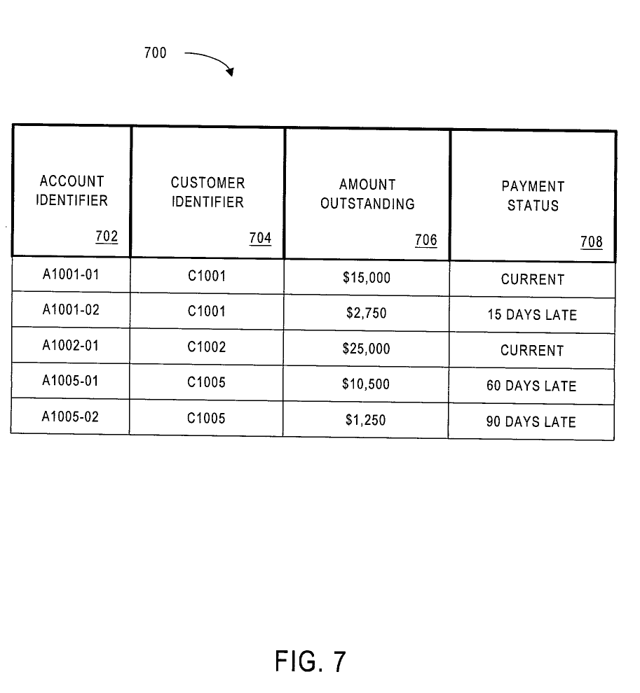

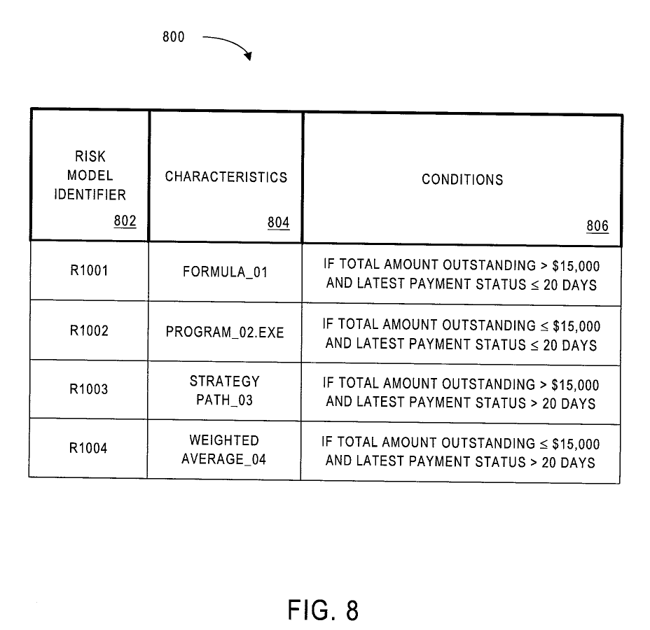

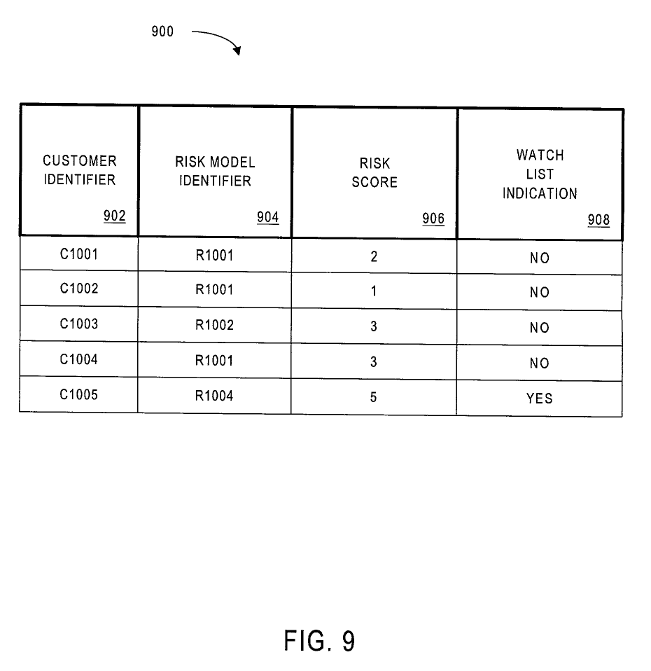

As shown in FIG. 5, the storage device 530 also stores a customer database 600 (described with respect to FIG. 6), an account database 700 (described with respect to FIG. 7), a risk model database 800 (described with respect to FIG. 8), and an analysis database 900 (described with respect to FIG. 9). Examples of databases that may be used in connection with controller 500 will now be described in detail with respect to FIGS. 6 through 9. The illustrations and accompanying descriptions of the databases presented herein are exemplary, and any number of other database arrangements could be employed besides those suggested by the figures.

Customer Database

Referring to FIG. 6, a table represents the customer database 600 that may be stored at the controller 500 according to an embodiment of the present invention. The table includes entries identifying customers that receive credit via one or more commercial credit accounts. The table also defines fields 602, 604, 606, 608 for each of the entries. The fields specify: a customer identifier 602, a customer name 604, a collateral type 606, and a geographic region 608.

The customer identifier 602 may be, for example, an alphanumeric code associated with a customer that receives credit via one or more commercial credit accounts. The customer name 604 identifies the customer, and the collateral type 606 indicates the type of collateral that is typically used to secure credit for that customer.

The geographic region 608 may indicate, for example, the customer's main place of business. The geographic region 608 may be used, for example, to generate risk information (e.g., each region may be associated with a different economic forecast) or to aggregate risk information on a portfolio basis (e.g., to determine the amount of risk associated with all “north east” commercial credit customers).

In general, the information in the customer database 600 may be used, for example, to select an appropriate risk model and/or to generate risk information.

Account Database

Referring to FIG. 7, a table represents the account database 700 that may be stored at the controller 500 according to an embodiment of the present invention. The table includes entries identifying commercial credit accounts being used to extend credit to customers. The table also defines fields 702, 704, 706, 708 for each of the entries. The fields specify: an account identifier 702, a customer identifier 704, an amount outstanding 706, and a payment status 708.

The account identifier 702 may be, for example, an alphanumeric code associated with a commercial credit account being used to extend credit to a customer The customer identifier 704 may be, for example, an alphanumeric code associated with the customer that is receiving credit and may be based on, or associated with, the customer identifier 602 stored in the customer database 600.

The amount outstanding 706 represents an amount currently owed by the customer with respect to the commercial credit account, and the payment status 708 indicates whether the customer's payment are presently “current” or “late.” The information in the account database 700 may be used, for example, the select an appropriate risk model and/or to generate risk information.

Risk Model Database

Referring to FIG. 8, a table represents the risk model database 800 that may be stored at the controller 500 according to an embodiment of the present invention. The table includes entries identifying risk models that may be applied to customer information to generate risk information. The table also defines fields 802, 804, 806 for each of the entries. The fields specify: a risk model identifier 802, characteristics 804, and conditions 806.

The risk model identifier 802 may be, for example, an alphanumeric code associated with a particular risk model that can be applied to customer information. The characteristics 804 may include, for example, a program, statistical variables, formulas, or other information that comprise the risk model. The characteristics 804 may also comprise a link or pointer associated with the risk model. The conditions 806 define when a particular model should be applied to customer information. For example, as illustrated by the third entry in FIG. 8, the “Strategy Path_{—}03” risk model should be applied if the total amount outstanding is more than $15,000 and the latest payment status is more than twenty days.

Analysis Database

Referring to FIG. 9, a table represents the analysis database 900 that may be stored at the controller 500 according to an embodiment of the present invention. The table includes entries identifying customer analysis information. The table also defines fields 902, 904, 906, 908 for each of the entries. The fields specify: a customer identifier 902, a risk model identifier 904, a risk score 906, and a watch list indication 908.

The customer identifier 902 may be, for example, an alphanumeric code associated with a customer receiving credit via one or more commercial credit accounts and may be based on, or associated with, the customer identifier 602 stored in the customer database 600 and/or the customer identifier 704 stored in the account database 700.

The risk model identifier 904 indicates one or more risk models that were used to analyze the customer and may be based on, or associated with, the risk model identifier 802 stored in the risk model database 800.

The risk score 906 represents the risk information generated by the risk model and the associated customer information (e.g., the collateral type 606 and geographic region 608 stored in the customer database 600 and the amount outstanding 706 and payment status 708 stored in the account database 700). The watch list indication 908 represents whether or not the customer should be included on a list of high risk customers (e.g., such as the display 400 illustrated in FIG. 4).

Commercial Credit Account Analysis

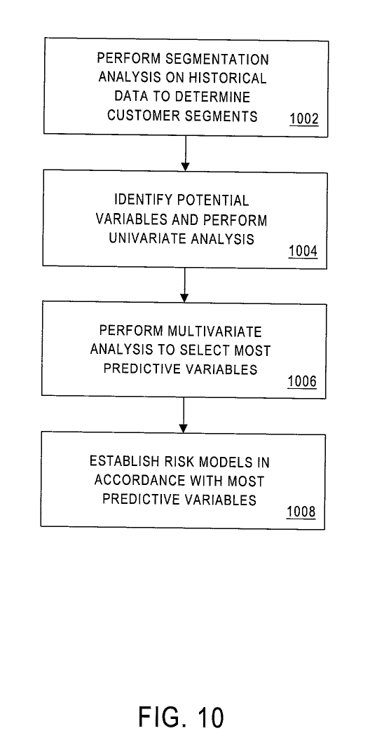

FIG. 10 is a flow chart of a method for generating risk models according to an embodiment of the present invention. The method may be performed, for example, by an employee associated with a creditor. Note that the method performed in FIG. 10 does not need to be performed on a periodic basis. That is, the same risk models may be used to score customer information a number of times. Of course, the risk models themselves may be monitored and updated as required to provide accurate scoring information.

At 1002, a segmentation analysis is performed on historical commercial credit information. At 1004, a univariate analysis is performed on a number of different potential variables (e.g., collateral type and amount outstanding) to identify potentially predictive variables. That is, these variables, standing alone, may provide some accurate risk information. A multivariate analysis is then performed on the potentially predictive variables to select most predictive variables 1006. That is, it may be determined which sets of variables accurately predicted losses associated with the historical commercial credit information.

At 1008, risk models are established using these most predictive variables for each customer segment. The characteristics 804 and conditions in the risk model database 800 may then be stored as appropriate.

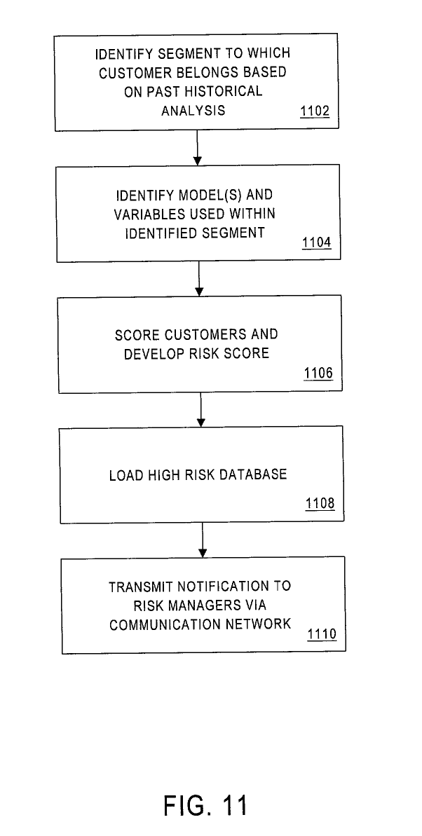

FIG. 11 is a flow chart of a computer-implemented method for identifying high risk customers according to an embodiment of the present invention. The method may be periodically performed, for example, by the controller 150 described with respect to FIG. 1.

At 1102, a segment to which a customer belongs is identified. For example, the controller 150 may retrieve the geographic region 608 stored in the customer database 600 and one or more payment status 708 indications stored in the account database 700 (e.g., each payment status 708 indication representing a different account associated with that customer) to identify an appropriate segment for the customer.

One or more appropriate risk models and associated variables are then identified 1104. For example, this information may be identified based on the characteristics 804 and conditions 806 stored the risk model database 800. Similarly, a risk model may be selected based on an account type (e.g., whether the account is associated with a lease or a loan). Internal account data is then retrieved (e.g., from the account database 700) and external customer data is received (e.g., from a third-party service 315).

The customers are then scored at 1106 based on the risk models, internal account data, and external customer data. For example, a risk model may use a gap between an expected collateral value and an amount outstanding adjusted by a probability of default to generate a risk score. The appropriate risk scores 906 may then be recorded in the analysis database 900.

According to some embodiments, a customer risk score is based on three factors: (i) a credit risk associated with customer payment trends and financial information, (ii) an economic risk associated with an industry or geographic region, and (iii) a deal risk based on the exposure, collateral, and term associated with one or more commercial credit accounts. These factors may then be combined to generate a composite risk score for the customer.

A high risk database is loaded at 1108. For example, all customers having a risk score 906 of “4” or “5” in the analysis database 900 may be loaded into the high risk database (i.e., the “watch list”). Other information may also be considered when loading the high risk database. For example, customers having a declining risk score trend may be more likely to be included. Similarly, customers having a large outstanding balance in excess of the value of any collateral may be more likely to be included.

A notification is then transmitted to risk managers via a communication network at 1110. For example, an electronic mail message indicating that the watch list has been updated might be transmitted to all risk manager. A risk manager could then access the high risk database using a risk manager device 130 (e.g., via the display 400 illustrated in FIG. 4).

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some of the embodiments described herein, a list is generated to represent the highest risk customers out of all existing commercial credit customers. According to the present invention, however, other types of lists may also be generated. For example, a list of the highest risk customers in a particular geographic region or industry may be generated. Similarly, a list including only newly risky customer may be generated (e.g., customers who were previously identified as high risk would not be included on such a list).

According to another embodiment, a risk manager is able to input information into a watch list display. For example, a risk manager may provide comments or indicate a work out status associated with the customer (e.g., stating that a “restructure” or “transfer and assumption” had occurred).

According to still another embodiment, the scoring information generated by the controller 150 is used in connection with a credit decision engine. For example, an active customer may approach a creditor and ask to open a new commercial credit account (e.g., in order to purchase a new truck). The creditor may then use the risk information associated with the customer to decide whether or not the customer's request will be granted (e.g., a request from a customer having a risk score 906 of “5” may automatically be declined by a decision engine).

Similarly, the scoring information generated by the controller 150 might be used to determine an amount of credit that can be extended to an active customer. For example, risk information associated with a customer may be used to determine that the customer can automatically access a $10,000 line of credit. Note that the actual amount of credit may or may not be disclosed to the customer.

According to still another embodiment, the scoring information generated by the controller 150 is used to solicit new business from active customers. For example, additional commercial credit accounts may be offered to all active customers having a risk score 905 of “1.” The scoring information may also be used to identify potential customers who do not current have any commercial credit accounts. Other information, such as the likelihood that a potential customer will accept an offer, may also be used to identify or prioritize potential customers.

In another embodiment, the scoring information generated by the controller 150 is used to ensure compliance with credit policy rules and guidelines (e.g., rules established by a chief risk officer). For example, risk managers may be authorized to extend only a pre-determined amount of credit to customers having a particular risk score. If the customer is seeking credit over that amount, the controller 150 may automatically notify the risk manager's supervisor (e.g., a party who is authorized to extend larger amounts of credit).

According to still another embodiment, the scoring information generated by the controller 150 is used to monitor portfolios. For example, the controller 150 may determine risk information associated with a portfolio as well as determining whether or not the portfolio is over concentrated (e.g., the portfolio has too many commercial credit accounts with machine tools as collateral).

In another embodiment, the scoring information generated by the controller 150 is used in connection with account collection activity. For example, a monthly watch list of high risk customers may be used to prioritize and focus collection activity on those customers and accounts having the highest risk.

According to yet another embodiment, the scoring information generated by the controller 150 is used to identify commercial credit customers and accounts to be sold via syndication activity. For example, customers having the highest risk scores may be selected to be sold.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for facilitating analysis of a commercial credit customer, comprising:
determining customer information associated with the commercial credit customer, at least some of the customer information being associated with a plurality of commercial credit accounts; and
generating risk information associated with the customer by applying at least one of a plurality of risk models to the customer information.

2. The method of claim 1, wherein said determining and generating are performed for a plurality of customers, and further comprising:
generating a list of high risk customers based on risk information.

3. The method of claim 2, further comprising:
periodically transmitting information associated with the list to a risk manager via a communication network.

4. The method of claim 1, wherein the customer information includes at least one of: (i) a business segment, (ii) a company type, and (iii) a product type.

5. The method of claim 1, wherein the customer information includes at least one of: (i) a customer characteristic, (ii) a payment history, (iii) a loss history, (iv) a delinquency status, and (v) an aggregate customer account size.

6. The method of claim 1, wherein the customer information includes at least one of: (i) an account characteristic, (ii) a collateral type, (iii) a delinquency status, (iv) an original account size, (v) an account duration, (vi) a total balance, (vii) a maximum total balance within a pre-determined period of time, (viii) an original equipment cost, (ix) a security deposit, (x) payment timing information, and (xi) payment amount information.

7. The method of claim 1, wherein the risk information comprises at least one of: (i) a risk score, and (ii) a risk category.

8. The method of claim 1, further comprising:
calculating a risk score based on the risk information, economic information, and deal information.

9. The method of claim 1, wherein the risk information is further based on information received from at least one third-party.

10. The method of claim 9, wherein the received information is associated with at least one of: (i) a customer, (ii) a customer category, and (iii) a plurality of customers.

11. The method of claim 1, wherein the plurality of risk models were created based on historical commercial credit information.

12. The method of claim 11, wherein the plurality of risk models were further created based on at least one of: (i) a segmentation analysis, (ii) a univariate analysis, and (iii) multivariate analysis.

13. The method of claim 1, further comprising:
selecting an appropriate risk model to apply to the customer information.

14. The method of claim 13, wherein said selecting is based on the customer information.

15. An apparatus, comprising:
a processor; and
a storage device in communication with said processor and storing instructions adapted to be executed by said processor to:
determine customer information associated with a commercial credit customer, at least some of the customer information being associated with a plurality of commercial credit accounts, and
generate risk information associated with the customer by applying at least one of a plurality of risk models to the customer information.

16. The apparatus of claim 15, wherein said storage device further stores at least one of: (i) a customer database, (ii) an account database, (iii) a risk model database, and (iv) an analysis database.

17. The apparatus of claim 15, further comprising:
a communication device coupled to said processor and adapted to communicate with at least one of: (i) an information device, (ii) an accounts receivable system, (iii) a third-party service, and (iv) a risk manager device.

18. A medium storing instructions adapted to be executed by a processor to perform a method for facilitating analysis of a commercial credit customer, said method comprising:
determining customer information associated with the commercial credit customer, at least some of the customer information being associated with a plurality of commercial credit accounts; and
generating risk information associated with the customer by applying at least one of a plurality of risk models to the customer information.

19. A method of facilitating commercial credit customer analysis, comprising:
identifying a set of historical customers, each historical customer being associated with at least one commercial credit account;
performing a segmentation analysis to determine customer segments;
identifying potential variables;
performing univariate analysis on the potential variables to identify potentially predictive variables;
performing multivariate analysis on the potentially predictive variables to select most predictive variables;
establishing risk models using the most predictive variables for each customer segment; and
for a plurality of active customers, periodically:
retrieving internal account data associated with the active customers,
receiving external customer data associated with the active customers,
identifying a subset of the active customers based on the risk models, internal account data, and external customer data, and
transmitting a notification associated with the subset of active customers to at least one risk manager via a communication network.
